(19) United States
(12) Patent Application Publication
(10) Pub. No.: US 2026/0310531 A1
(43) Pub. Date: Oct. 8, 2026

(54) SYSTEM AND METHOD USING USER LAYER NETWORK SOLUTION

(71) Applicant: SAMSUNG ELECTRONICS CO., LTD., Suwon-si (KR)

(72) Inventor: Jongeon PARK, Suwon-si (KR)

(21) Appl. No.: 19/680,361

(22) Filed: May 18, 2026

Related U.S. Application Data
(63) Continuation of application No. PCT/KR2024/017289, filed on Nov. 5, 2024.

(30) Foreign Application Priority Data
Dec. 20, 2023 (KR) 10-2023-0187038
Jan. 8, 2024 (KR) 10-2024-0003012

(51) Int. Cl. G06F 9/54

(52) U.S. Cl. CPC G06F 9/547; G06F 9/545; G06F 2209/541

(57) ABSTRACT

A system and method using a user-layer network solution (ULNs), and may include: when a ULNs loader detects execution of an application program, checking whether a ULNs manager of the application program exists; when the ULNs manager of the application program exists based on a result of the checking, loading, by the ULNs loader, the ULNs manager of the application program; when the application program calls a function related to a network, if the ULNs manager of application program exists, transmitting, by a system call hooker, the called function to the ULNs manager; and when the ULNs manager receives the called function, calling the called function by changing a parameter to match the form of a corresponding function of a ULNs, and when a response corresponding to the called function is received, changing the response to match the form of a library and transmitting the response to the application program.

### CROSS-REFERENCE TO RELATED APPLICATIONS

This application is a continuation of International Application No. PCT/KR2024/017289 designating the United States, filed on Nov. 5, 2024, in the Korean Ministry of Intellectual Property Receiving Office and claiming priority to Korean Patent Application Nos. 10-2023-0187038, filed on Dec. 20, 2023, and 10-2024-0003012, filed on Jan. 8, 2024, in the Korean Ministry of Intellectual Property, the disclosures of each of which are incorporated by reference herein in their entireties.

### BACKGROUND

### Field

The disclosure relates to an operating system and to technology using a user-layer network solution (ULNs).

### Description of Related Art

Generally, network functions are implemented inside the kernel of an operating system, where a transmission control protocol (TCP), an Internet protocol (IP), a network interface card (NIC) driver, and the like, which are commonly mentioned, are implemented. A portion where sockets, packet filters, and routes are implemented to enable application programs to use these TCP/IP protocols is referred to as a 'network stack.'

As the network infrastructure speed increases and the amount of data that needs to be processed in a terminal and server increases, the network packet processing speed becomes critical. Therefore, network packet processing must have high priority and be processed at high speed, but since network packet processing must not affect other tasks, it is generally processed within a kernel.

While it is common for a network stack to be implemented in an operating system, there are several limitations due to its implementation in a kernel. Consequently, cases have emerged in which a network stack for processing a network packet is implemented at the user layer, rather than the kernel, for the specific purpose of an application program.

However, when applying a currently commercialized user-layer network solution (ULNs), it is necessary to redevelop an application program to process a network using a proprietary framework or application programming interface (API) defined by the solution; however, such APIs are not standardized across different solutions, and even if implemented in a form similar to a standard library (libc) API, they are not directly compatible with a file descriptor (fd), which is a socket resource management number obtained through the system. As a result, it becomes impossible to receive event notifications simultaneously for fds generated through the system and fds obtained through the ULNs; consequently, if an application program is implemented to receive a single event notification for file resources during the use of network resources, a modification of the existing implementation is inevitable.

When an application program calls one of the functions poll, select, and epoll_wait to receive an event notification, control is transferred to the system until the function returns. When receiving the event notification, an fd is used, and the fd is not limited to being received one at a time, but a plurality of fds may be received together to collectively process event completions. If an fd of a socket generated from a ULNs, an fd for file input/output (I/O) generated by a system, and an fd for a pipe are received together by an event notification function, a method of simultaneously processing them at a time is required.

### SUMMARY

A method of using a user-layer network solutions (ULNs), according to an example embodiment, includes: determining, based on a ULNs loader detecting an execution of an application program, whether a ULNs manager corresponding to the application program exists, loading, by the ULNs loader, the ULNs manager corresponding to the application program based on, as a result of the determination, the ULNs manager corresponding to the application program existing, transmitting, by a system call hooker, based on the application program calling a function related to a network, the called function to the ULNs manager based on the ULNs manager corresponding to the application program existing, and calling, based on the ULNs manager receiving the called function, the called function by changing a parameter of the called function to match the form of a corresponding function of a ULNs and transmitting, based on receiving a response corresponding to the called function, the response to the application program by changing the response to match the form of a library.

A system for using a user-layer network solutions (ULNs), according to an example embodiment, includes memory and at least one processor, comprising processing circuitry, wherein at least one processor, individually or in any combination, is configured to cause the system to: determine, based on a ULNs loader detecting an execution of an application program, whether a ULNs manager corresponding to the application program exists, load, through the ULNs loader, the ULNs manager corresponding to the application program based on, as a result of the determination, the ULNs manager corresponding to the application program existing, transmit, through a system call hooker, based on the application program calling a function related to a network, the called function to the ULNs manager based on the ULNs manager corresponding to the application program existing, call, based on the ULNs manager receiving the called function, the called function by changing a parameter of the called function to match the form of a corresponding function of a ULNs and transmit, based on receiving a response corresponding to the called function, the response to the application program by changing the response to match the form of a library.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example configuration of a system for using a user-layer network solution (ULNs), according to various example embodiments.

FIG. 2 is a flowchart illustrating an example method of allowing a ULNs to be used in an application program, according to various example embodiments.

FIG. 3 is a flowchart illustrating an example method of generating a socket when a ULNs is used in an application program, according to various example embodiments.

FIG. 4 is a flowchart illustrating an example method of performing a connect function when a ULNs is used in an application program, according to various example embodiments.

FIG. 5 is a flowchart illustrating an example method of performing a send function when a ULNs is used in an application program, according to various example embodiments.

FIG. 6 is a flowchart illustrating an example method of performing a receive function when a ULNs is used in an application program, according to various example embodiments.

FIG. 7 is a flowchart illustrating an example method of processing an event completion notification related to a reception in an asynchronous input/output (I/O) scheme when a ULNs is used in an application program, according to various example embodiments.

FIG. 8 is a flowchart illustrating an example method of processing an event completion notification related to a transmission in an asynchronous I/O scheme when a ULNs is used in an application program, according to various example embodiments.

FIG. 9 is a block diagram illustrating an example configuration of an electronic device using a ULNs, according to various example embodiments.

FIG. 10 is a block diagram illustrating an example electronic device in a network environment, according to various example embodiments.

### DETAILED DESCRIPTION

Hereinafter, various example embodiments are described in greater detail with reference to the accompanying drawings. However, various alterations and modifications may be made to the various embodiments. Here, the disclosure is not intended to be limited by the various example embodiments. The disclosure should be understood to include all changes, equivalents, and replacements of the various embodiments within the technical scope of the disclosure.

The terminology used herein is for the purpose of describing various embodiments only and is not to be limiting of the disclosure. As used herein, the singular form is intended to include the plural forms as well, unless the context clearly indicates otherwise. It will be further understood that the terms "comprises/comprising" or "includes/including" when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which the disclosure belongs. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the various embodiments with reference to the accompanying drawings like reference numerals refer to like components and a repeated description related thereto may not be provided. In the description of various embodiments, detailed description of well-known related technology may be omitted when it is deemed that such description will cause ambiguous interpretation of the disclosure.

The terms first, second, A, B, (a), and (b) may be used to describe components of the various embodiments. These terms are used only for the purpose of discriminating one component from another component, and the nature, the sequences, or the orders of the components are not limited by the terms. When one component is described as being "connected," "coupled," or "attached" to another component, it should be understood that one component may be connected or attached directly to another component, and an intervening component may also be "connected," "coupled," or "attached" to the components.

Components included in an example and components that have common functions will be described using the same names in various embodiments. Unless stated otherwise, the description of any one example may be applied to other embodiments, and the specific description of the repeated configuration may not be provided.

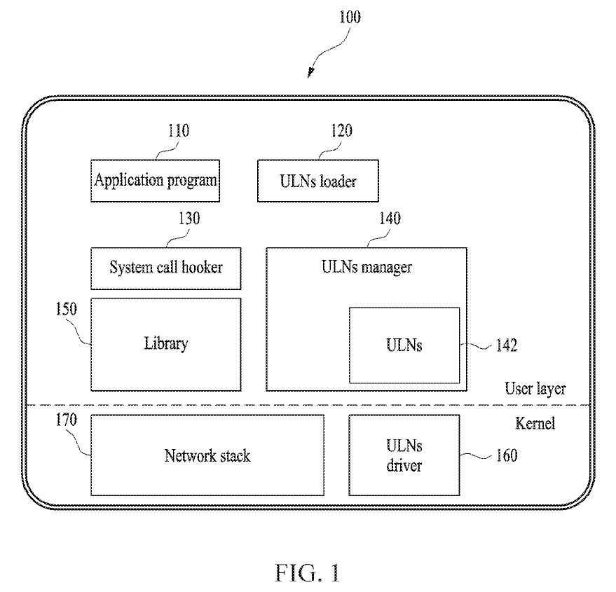

Hereinafter, a system and method for using a user-layer network solution (ULNs) are described in greater detail with reference to FIGS. 1-9, according to various example embodiments of the present disclosure.

FIG. 1 is a diagram illustrating an example configuration of a system for using a ULNs, according to various example embodiments.

Referring to FIG. 1, a system 100 may include an application program 110, a ULNs loader 120, a system call hooker 130, a ULNs manager 140, a ULNs 142, a library 150, a ULNs driver 160, and a network stack 170, each of which may include various circuitry and/or executable program instructions. The application program 110, the ULNs loader 120, the system call hooker 130, the ULNs manager 140, the ULNs 142, and the library 150 may be programs that operate at a user layer of an operating system of a single device including the system 100.

The application program 110 may refer to a program that uses a network and may use a network stack or a ULNs.

The ULNs loader 120, may refer to a component that determines whether to load the ULNs manager 140 when executing the application program 110, may determine whether to load the ULNs manager 140 by determining whether the application program 110 is previously registered as an application program that uses a ULNs.

When the application program 110 does not use a ULNs and uses the library 150, the system call hooker 130 may bypass a function call of the application program 110 to the library 150 and may call a function of the library 150.

When the application program 110 uses the ULNs 142, the system call hooker 130 may transmit the function call of the application program 110 to the ULNs manager 140.

The system calls (syscalls) hooked by the system call hooker 130 may be limited to an application programming interface (API) required for network processing (for example, socket, connect, recv, send, poll/select/epoll_wait, etc.).

The ULNs manager 140 may include and manage the ULNs 142 corresponding to the application program 110 when the application program 110 uses the ULNs 142. When the application program 110 is executed and loaded by the ULNs loader 120, the ULNs manager 140 may allow the application program 110 to use the ULNs 142 in real time.

The ULNs manager 140 may communicate directly with the ULNs driver 160 via input output control (ioctl) and may map the resources of a kernel (a socket, a file descriptor, etc.) to the resources of the ULNs 142.

The ULNs 142 may be a component that allows network communication at the user layer.

The application program 110, the system call hooker 130, the ULNs manager 140, and the ULNs 142 may be matched on a one-to-one basis. For example, when the application program 110 is executed and uses a ULNs, the system call hooker 130, the ULNs manager 140, and the ULNs 142 only for the application program 110 may be loaded.

The library 150, which may refer to a collection of pieces of programming code used for system software and application programs to interact with an operating system, may wrap the syscalls of the operating system.

The ULNs driver 160 may include a component that provides resource information of a system to be mapped by the ULNs manager 140. In particular, the ULNs driver 160 may enable a value to be known in real time through a technique, such as memory mapping (mmap), to inform the ULNs manager 140 of the content related to a transmit queue and a receive queue in a socket structure belonging to the system and may enable necessary command processing through ioctl.

The network stack 170 may include a component that processes a network packet in the system 100. The network stack 170 may collectively refer to a socket serving as a window for data input/output in an application program, a part implementing a transport layer, such as a transmission control protocol (TCP)/user datagram protocol (UDP), a part implementing a protocol layer, such as an Internet protocol (IP), and a network interface card (NIC) driver part processing hardware (H/W) input/output.

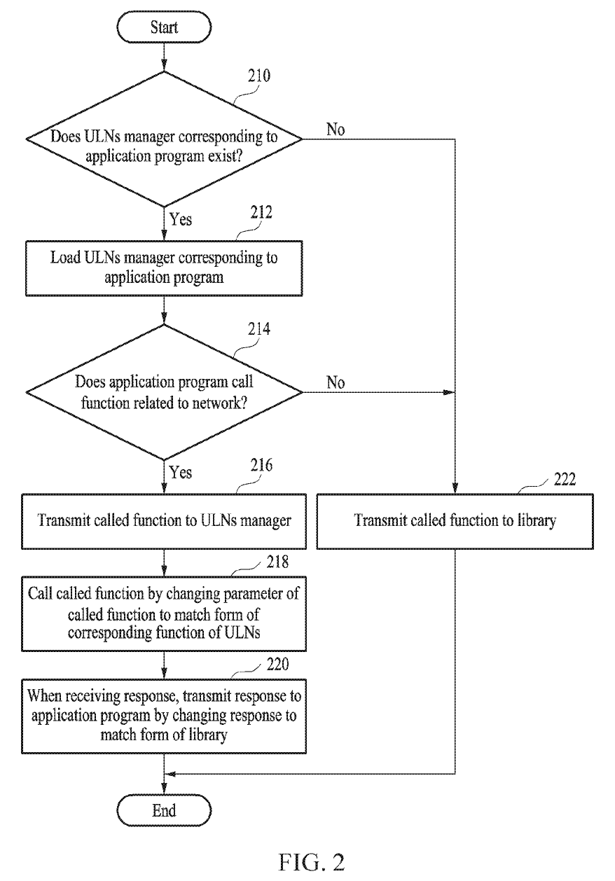

A method of using a ULNs using various components of the system 100 is described in greater detail below with reference to FIGS. 2-8.

FIG. 2 is a flowchart illustrating an example method of allowing a ULNs to be used in an application program, according to various example embodiments.

Referring to FIG. 2, in operation 210, when the ULNs loader 120 of the present disclosure detects an execution of the application program 110, it may be determined whether the ULNs manager 140 corresponding to the application program 110 exists.

When the ULNs manager 140 corresponding to the application program 110 exists as a result of the determination in operation 210, in operation 212, the ULNs loader 120 may load the ULNs manager 140 corresponding to the application program 110.

In operation 214, the system call hooker 130 may determine whether a called function by the application program 110 is a function related to a network.

When the called function by the application program 110 is a function related to a network as a result of the determination in operation 214, the system call hooker 130 may transmit the called function to the ULNs manager 140 in operation 216.

When the ULNs manager 140 receives the called function, the called function may be called by changing a parameter of the called function to match the form of a corresponding function of the ULNs 142 in operation 218.

When the ULNs manager 140 receives a response corresponding to the called function, the response may be transmitted to the application program 110 by changing the response to match the form of the library 150 in operation 220.

When the ULNs manager 140 corresponding to the application program 110 does not exist as a result of the determination in operation 210, in operation 222, the system call hooker 130 may transmit a function to be called later to the library 150.

When the called function is not a function related to a network as a result of the determination in operation 214, in operation 222, the system call hooker 130 may transmit the called function to the library 150.

Since the operation after the called function is transmitted to the library 150 in operation 222 corresponds to a conventional general operation, a detailed description of the subsequent operation may not be provided here.

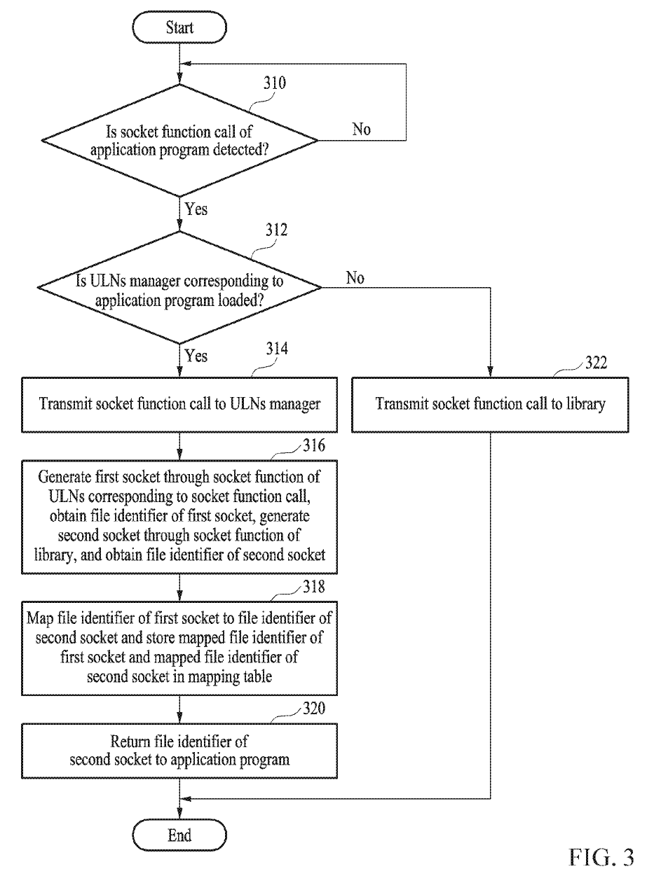

FIG. 3 is a flowchart illustrating an example method of generating a socket when a ULNs is used in an application program, according to various example embodiments.

Referring to FIG. 3, when the system call hooker 130 detects a socket function call of the application program 110 in operation 310, in operation 312, it may be determined whether the ULNs manager 140 corresponding to the application program 110 is loaded.

When the ULNs manager 140 corresponding to the application program 110 is loaded, as a result of the determination in operation 312, in operation 314, the system call hooker 130 may transmit the socket function call to the ULNs manager 140.

When the ULNs manager 140 receives the socket function call, in operation 316, a first socket may be generated through a socket function of the ULNs 142 corresponding to the socket function call, a file identifier of the first socket may be obtained, a second socket may be generated through a socket function of the library 150, and a file identifier of the second socket may be obtained. The file identifier may be a file descriptor.

In operation 318, the ULNs manager 140 may map the file identifier of the first socket to the file identifier of the second socket and may store the mapped file identifier of the first socket and the mapped file identifier of the second socket in a mapping table.

In operation 320, the ULNs manager 140 may return the file identifier of the second socket to the application program 110.

When the ULNs manager 140 corresponding to the application program 110 is not loaded, as a result of the determination in operation 312, in operation 322, the system call hooker 130 may transmit the socket function call to the library 150.

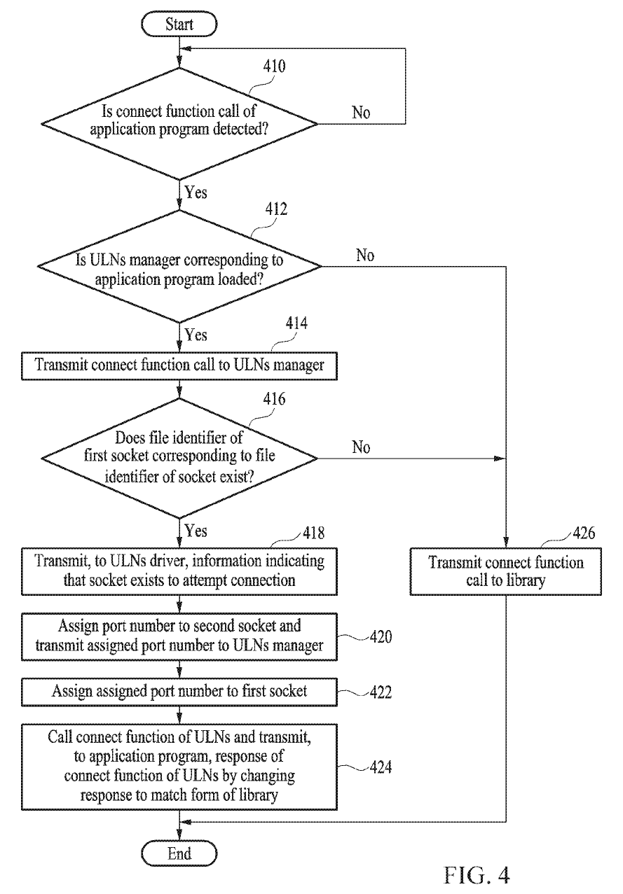

FIG. 4 is a flowchart illustrating an example method of performing a connect function when a ULNs is used in an application program, according to various example embodiments.

Referring to FIG. 4, when the system call hooker 130 detects a connect function call of the application program 110 in operation 410, in operation 412, it may be determined whether the ULNs manager 140 corresponding to the application program 110 is loaded.

When the ULNs manager 140 corresponding to the application program 110 is loaded, as a result of the determination in operation 412, in operation 414, the system call hooker 130 may transmit the connect function call to the ULNs manager 140.

When the ULNs manager 140 receives the connect function call, in operation 416, it may be determined, by determining a file identifier of a socket included in the connect function call through the mapping table, whether a file identifier of a first socket corresponding to the file identifier of the socket exists.

When the file identifier of the first socket corresponding to the file identifier of the socket included in the connect function call exists, as a result of the determination in operation 416, in operation 418, the ULNs manager 140 may transmit, to the ULNs driver 160, information indicating that a socket exists to attempt a connection.

In operation 420, the ULNs driver 160 may assign a port number to a second socket and transmit the assigned port number to the ULNs manager 140.

In operation 422, the ULNs manager 140 may also assign the assigned port number to the first socket.

In operation 424, the ULNs manager 140 may call a connect function of the ULNs 142, and when receiving a response of the connect function of the ULNs 142, the ULNs manager 140 may transmit, to the application program 110, the response of the connect function of the ULNs 142 by changing the response to match the form of the library 150.

When the ULNs manager 140 corresponding to the application program 110 is not loaded, as a result of the determination in operation 412, in operation 426, the system call hooker 130 may transmit the connect function call to the library 150.

When the file identifier of the first socket corresponding to the file identifier of the socket included in the connect function call does not exist, as a result of the determination in operation 416, in operation 426, the ULNs manager 140 may transmit the connect function call to the library 150.

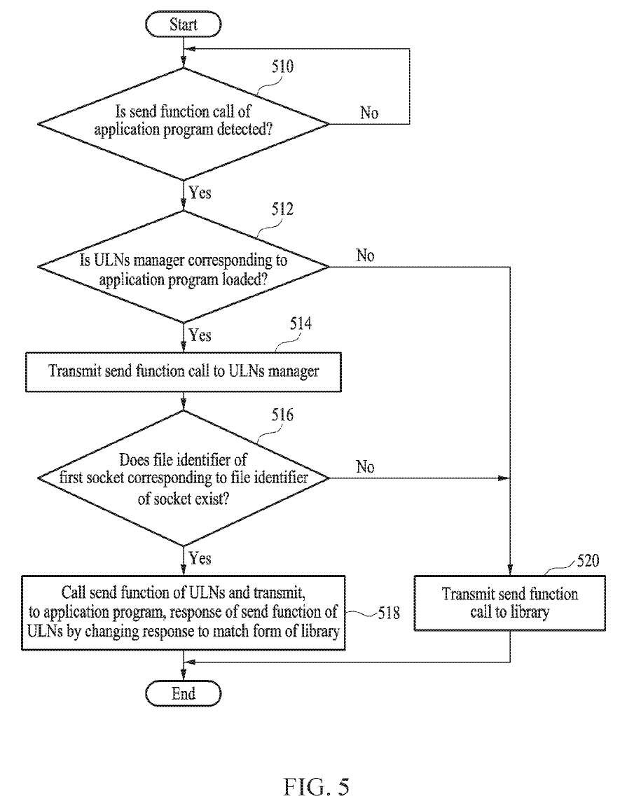

FIG. 5 is a flowchart illustrating an example method of performing a send function when a ULNs is used in an application program, according to various example embodiments.

Referring to FIG. 5, when the system call hooker 130 detects a send function call of the application program 110 in operation 510, in operation 512, it may be determined whether the ULNs manager 140 corresponding to the application program 110 is loaded.

When the ULNs manager 140 corresponding to the application program 110 is loaded, as a result of the determination in operation 512, in operation 514, the system call hooker 130 may transmit the send function call to the ULNs manager 140.

When the ULNs manager 140 receives the send function call, in operation 516, it may be determined, by determining a file identifier of a socket included in the send function call through a mapping table, whether a file identifier of a first socket corresponding to the file identifier of the socket exists.

When the file identifier of the first socket corresponding to the file identifier of the socket included in the send function call exists, as a result of the determination in operation 516, in operation 518, the ULNs manager 140 may call a send function of the ULNs 142, and when receiving a response of the send function of the ULNs 142, the ULNs manager 140 may transmit, to the application program 110, the response of the send function of the ULNs 142 by changing the response to match the form of the library 150.

When the ULNs manager 140 corresponding to the application program 110 is not loaded, as a result of the determination in operation 512, in operation 520, the system call hooker 130 may transmit the send function call to the library 150.

When the file identifier of the first socket corresponding to the file identifier of the socket included in the send function call does not exist, as a result of the determination in operation 516, in operation 520, the ULNs manager 140 may transmit the send function call to the library 150.

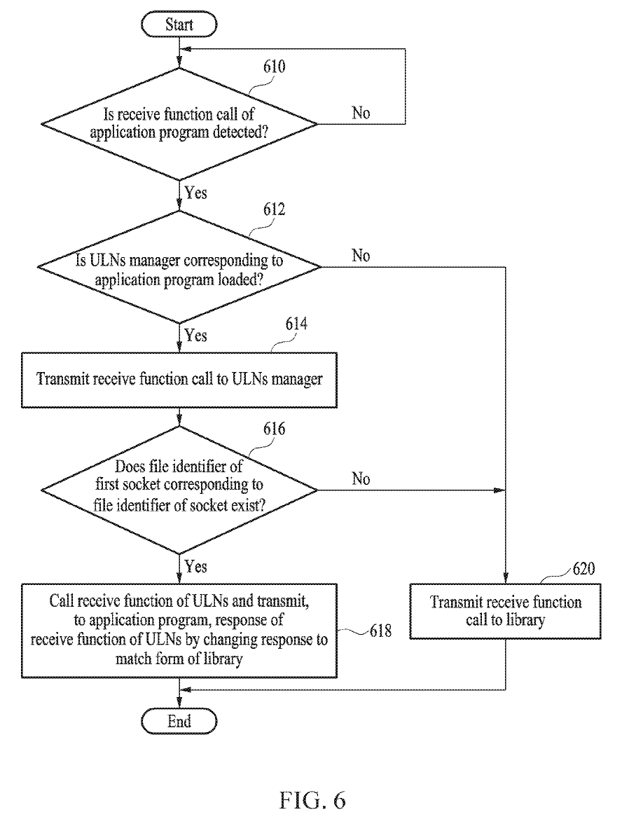

FIG. 6 is a flowchart illustrating an example method of performing a receive function when a ULNs is used in an application program, according to various example embodiments.

Referring to FIG. 6, when the system call hooker 130 detects a receive function call of the application program 110 in operation 610, in operation 612, it may be determined whether the ULNs manager 140 corresponding to the application program 110 is loaded.

When the ULNs manager 140 corresponding to the application program 110 is loaded, as a result of the determination in operation 612, in operation 614, the system call hooker 130 may transmit the receive function call to the ULNs manager 140.

When the ULNs manager 140 receives the receive function call, in operation 616, it may be determined, by determining a file identifier of a socket included in the receive function call through a mapping table, whether a file identifier of a first socket corresponding to the file identifier of the socket exists.

When the file identifier of the first socket corresponding to the file identifier of the socket included in the receive call exists, as a result of the determination in operation 616, in operation 618, the ULNs manager 140 may call a receive function of the ULNs 142, and when receiving a response of the receive function of the ULNs 142, the ULNs manager 140 may transmit, to the application program 110, the response of the receive function of the ULNs 142 by changing the response to match the form of the library 150.

When the ULNs manager 140 corresponding to the application program 110 is not loaded, as a result of the determination in operation 612, in operation 620, the system call hooker 130 may transmit the receive function call to the library 150.

When the file identifier of the first socket corresponding to the file identifier of the socket included in the receive function call does not exist, as a result of the determination in operation 616, in operation 620, the ULNs manager 140 may transmit the receive function call to the library 150.

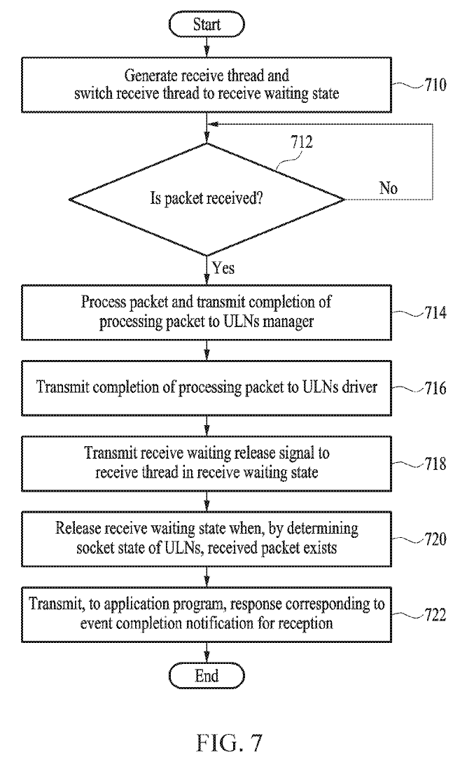

FIG. 7 is a flowchart illustrating an example method of processing an event completion notification related to a reception in an asynchronous input/output (I/O) scheme when a ULNs is used in an application program, according to various example embodiments.

Referring to FIG. 7, in operation 710, the application program 110 may generate a receive thread for receiving and may switch the receive thread to a receive waiting state. An event notification function that switches the receive thread to the receive waiting state may be one of poll, select, and epoll_wait. poll, select, and epoll_wait are event notification functions capable of processing a plurality of file identifiers simultaneously, and the characteristics of each function may be as follows. The poll function returns a structure, populated with event information and a file identifier where an event occurs, which may be used to recognize the completion of a task, but the maximum number of identifiers that may receive an event notification is limited to 1,024, 4,096, or the like. The select function may cause a performance issue because a user must directly find for which file identifier the completion occurs through a sequential search. The epoll_wait function is added to compensate for the shortcomings of the poll and select functions, but some old operating systems or platforms do not support the epoll_wait function, and the APIs are divided into epoll_create, epoll_ctl, etc., which may be cumbersome to use. In the case of monitoring an event with a simple structure, the poll function has an advantage in performance, so the appropriate API among the three may be selected and used depending on the purpose of an application program.

When the ULNs 142 receives a packet through a network in operation 712, in operation 714, the packet may be processed, and the completion of processing the packet may be transmitted to the ULNs manager 140.

In operation 716, the ULNs manager 140 may transmit the completion of processing the packet to the ULNs driver 160.

In operation 718, when the ULNs driver 160 receives the completion of processing the packet, a receive waiting release signal may be transmitted to the receive thread in the receive waiting state.

When the receive thread receives the receive waiting release signal, in operation 720, the receive waiting state may be released when, by determining a socket state of the ULNs 142, the received packet exists.

In operation 722, the receive thread may transmit, to the application program 110, a response corresponding to an event completion notification for reception.

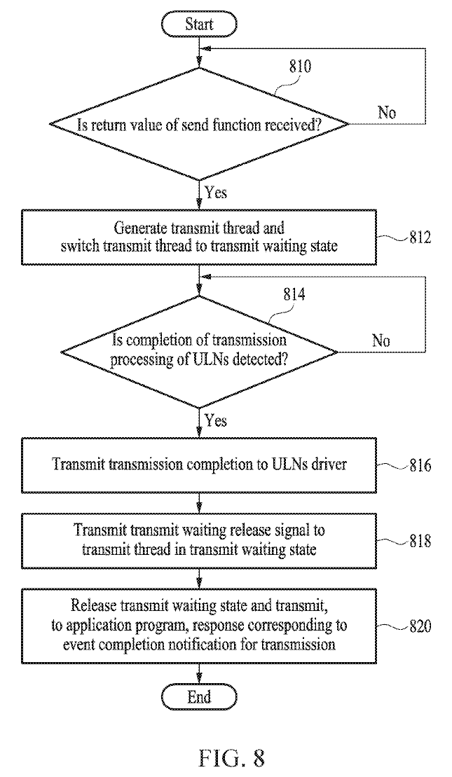

FIG. 8 is a flowchart illustrating an example method of processing an event completion notification related to a transmission in an asynchronous I/O scheme when a ULNs is used in an application program, according to various example embodiments.

Referring to FIG. 8, when the application program 110 receives a response of a send function in operation 810, in operation 812 a transmit thread for transmitting may be generated and the transmit thread may be switched to a transmit waiting state. An event notification function that switches the transmit thread to the transmit waiting state may be one of poll, select, and epoll_wait.

When the ULNs manager 140 detects the completion of transmission processing of the ULNs 142 in operation 814, in operation 816, a transmission completion indicating that the transmission is completed may be transmitted to the ULNs driver 160.

When the ULNs driver 160 receives the transmission completion, in operation 818, a transmit waiting release signal may be transmitted to the transmit thread in the transmit waiting state.

When the transmit thread receives the transmit waiting release signal, in operation 820, the transmit waiting state may be released and a response corresponding to an event completion notification for transmission may be transmitted to the application program 110.

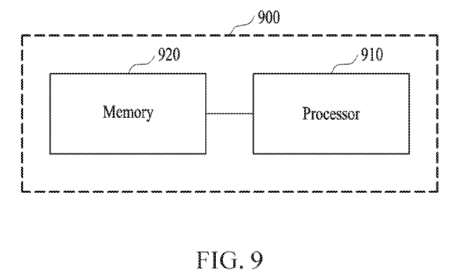

FIG. 9 is a block diagram illustrating an example configuration of an electronic device using a ULNs, according to various example embodiments.

Referring to FIG. 9, an electronic device 900 may include a processor (e.g., including processing circuitry) 910 and memory 920.

The memory 920 may store an operating system (OS), an application program, and storage data for controlling the overall operation of the electronic device 900. The memory 920 may store an application program and information regarding the application program using a ULNs, according to the present disclosure.

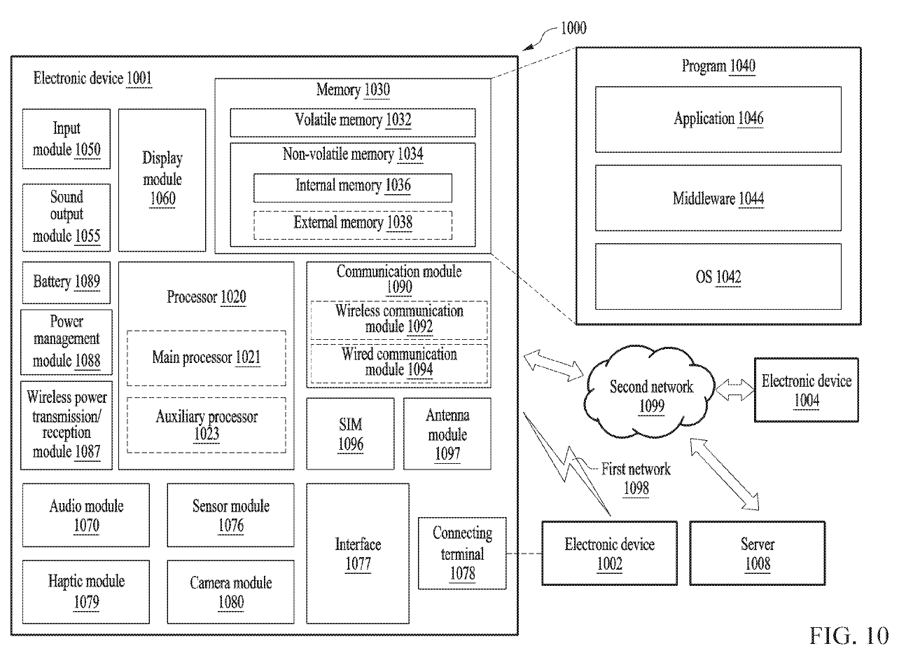

The processor 910 may include various processing circuitry and operate the system 100 of FIG. 1. For example, the processor 910 may include the configuration of the system 100 of FIG. 1. For a detailed description of the processor 910 reference is made to the processor 1020 of FIG. 10, and a detailed description of the processor 910 is not repeated here. Further, when it is described below that the processor 910 “causes” an operation to occur it may refer to the processor 910 causing the system to perform the recited function.

The processor 910 may cause, when the ULNs loader 120 detects an execution of the application program 110, the ULNs loader 120 to determine whether the ULNs manager 140 corresponding to the application program 110 exists. The processor 910 may cause, when, as a result of the determination, the ULNs manager 140 corresponding to the application program 110 exists, the ULNs loader 120 to load the ULNs manager 140 corresponding to the application program 110. The processor 910 may cause, when the application program 110 calls a function related to a network, the system call hooker 130 to transmit the called function to the ULNs manager 140 when the ULNs manager 140 corresponding to the application program 110 exists. The processor 910 may cause, when the ULNs manager 140 receives the called function, the ULNs manager 140 to call the called function by changing a parameter of the called function to match the form of a corresponding function of the ULNs 142. The processor 910 may cause, when receiving a response corresponding to the called function, the ULNs manager 140 to transmit, to the application program 110, the response by changing the response to match the form of the library 150.

The processor 910, when the ULNs manager 140 corresponding to the application program 110 does not exist, may cause the system call hooker 130 to transmit the called function to the library 150.

The processor 910 may cause, when the system call hooker 130 detects a socket function call of the application program 110, the system call hooker 130 to determine whether the ULNs manager 140 corresponding to the application program 110 is loaded. The processor 910 may cause, when the ULNs manager 140 corresponding to the application program 110 is loaded, the system call hooker 130 to transmit the socket function call to the ULNs manager 140. The processor 910 may cause, when the ULNs manager 140 receives the socket function call, the ULNs manager 140 to generate a first socket through a socket function of the ULNs 142 corresponding to the socket function call, to obtain a file identifier of the first socket, to generate a second socket through a socket function of the library 150, and to obtain a file identifier of the second socket. The processor 910 may cause the ULNs manager 140 to map the file identifier of the first socket to the file identifier of the second socket and to store the mapped file identifier of the first socket and the mapped file identifier of the second socket in a mapping table. The processor 910 may cause the ULNs manager 140 to return the file identifier of the second socket to the application program 110.

The processor 910 may cause, when the ULNs manager 140 corresponding to the application program 110 is not loaded, the system call hooker 130 to transmit the socket function call to the library 150.

The processor 910 may cause, when the system call hooker 130 detects a connect function call of the application program 110, the system call hooker 130 to determine whether the ULNs manager 140 corresponding to the application program 110 is loaded. The processor 910 may cause, when the ULNs manager 140 corresponding to the application program 110 is loaded, the system call hooker 130 to transmit the connect function call to the ULNs manager 140. The processor 910 may cause, when the ULNs manager 140 receives the connect function call, the ULNs manager 140 to determine, by determining a file identifier of a socket included in the connect function call through a mapping table, whether a file identifier of a first socket corresponding to the file identifier of the socket exists. The processor 910 may cause, when, as a result of the determination, the file identifier of the first socket corresponding to the file identifier of the socket included in the connect function call exists, the ULNs manager 140 to transmit, to the ULNs driver 160, information indicating that a socket exists to attempt a connection. The processor 910 may cause the ULNs driver 160 to assign a port number to a second socket. The processor 910 may cause the ULNs driver 160 to transmit the assigned port number to the ULNs manager 140. The processor 910 may cause the ULNs manager 140 to assign the assigned port number to the first socket. The processor 910 may cause the ULNs manager 140 to call a connect function of the ULNs 142. The processor 910 may cause, when receiving a response of the connect function of the ULNs 142, the ULNs manager 140 to transmit, to the application program 110, the response of the connect function of the ULNs 142 by changing the response to match the form of the library 150.

The processor 910 may cause, when the ULNs manager 140 corresponding to the application program 110 is not loaded, the system call hooker 130 to transmit the connect function call to the library 150.

The processor 910 may cause, when the file identifier of the first socket corresponding to the file identifier of the socket included in the connect function call does not exist, the ULNs manager 140 to transmit the connect function call to the library 150.

The processor 910 may cause, when the system call hooker 130 detects a send function call of the application program 110, the system call hooker 130 to determine whether the ULNs manager 140 corresponding to the application program 110 is loaded. The processor 910 may cause, when the ULNs manager 140 corresponding to the application program 110 is loaded, the system call hooker 130 to transmit the send function call to the ULNs manager 140. The processor 910 may cause, when the ULNs manager 140 receives the send function call, the ULNs manager 140 to determine, by determining a file identifier of a socket included in the send function call through a mapping table, whether a file identifier of a first socket corresponding the file identifier of the socket exists. The processor 910 may cause, when, as a result of the determination, the file identifier of the first socket corresponding to the file identifier of the socket included in the send function call exists, the ULNs manager 140 to call a send function of the ULNs 142. The processor 910 may cause, when receiving a response of the send function of the ULNs 142, the ULNs manager 140 to transmit, to the application program 110, the response of the send function of ULNs 142 by changing the response to match the form of the library 150.

The processor 910 may cause, when the ULNs manager 140 corresponding to the application program 110 is not loaded, the system call hooker 130 to transmit the send function call to the library 150.

The processor 910 may cause, when the file identifier of the first socket corresponding to the file identifier of the socket included in the send function call does not exist, the ULNs manager 140 to transmit the send function call to the library 150.

The processor 910 may cause, when the system call hooker 130 detects a receive function call of the application program 110, the system call hooker 130 to determine whether the ULNs manager 140 corresponding to the application program 110 is loaded. The processor 910 may cause, when the ULNs manager 140 corresponding to the application program 110 is loaded, the system call hooker 130 to transmit the receive function call to the ULNs manager 140. The processor 910 may cause, when the ULNs manager 140 receives the receive function call, the ULNs manager 140 to determine, by determining a file identifier of a socket included in the receive function call through a mapping table, whether a file identifier of a first socket corresponding the file identifier of the socket exists. The processor 910 may cause, when, as a result of the determination, the file identifier of the first socket corresponding to the file identifier of the socket included in the receive call exists, the ULNs manager 140 to call a receive function of the ULNs 142. The processor 910 may cause, when receiving a response of the receive function of the ULNs 142, the ULNs manager 140 to transmit, to the application program 110, the response of the receive function of the ULNs 142 by changing the response to match the form of the library 150.

The processor 910 may cause, when the ULNs manager 140 corresponding to the application program 110 is not loaded, the system call hooker 130 to transmit the receive function call to the library 150.

The processor 910 may cause, when the file identifier of the first socket corresponding to the file identifier of the socket included in the receive function call does not exist, the ULNs manager 140 to transmit the receive function call to the library 150.

The processor 910 may cause the application program 110 to generate a receive thread for receiving and to switch the receive thread to a receive waiting state. The processor 910 may cause, when the ULNs 142 receives a packet through a network, the ULNs 142 to process the packet and to transmit a completion of processing the packet to the ULNs manager 140. The processor 910 may cause the ULNs manager 140 to transmit the completion of processing the packet to the ULNs driver 160. The processor 910 may cause, when the ULNs driver 160 receives the completion of processing the packet, the ULNs driver 160 to transmit a receive waiting release signal to the receive thread in the receive waiting state. The processor 910 may cause, when the receive thread receives the receive waiting release signal, the ULNs driver 160 to release, by determining a socket state of the ULNs 142, the receive waiting state when the received packet exists and to transmit, to the application program 110, a response corresponding to an event completion notification for reception.

The processor 910 may cause, when the application program 110 receives a response of a send function, the application program 110 to generate a transmit thread for transmitting and to switch the transmit thread to a transmit waiting state. The processor 910 may cause, when the ULNs manager 140 detects a completion of transmission processing of the ULNs 142, the ULNs manager 140 to transmit, to the ULNs driver 160, a transmission completion indicating that the transmission is completed. The processor 910 may cause, when the ULNs driver 160 receives the transmission completion, the ULNs driver 160 to transmit a transmit waiting release signal to the transmit thread in the transmit waiting state. The processor 910 may cause, when the transmit thread receives the transmit waiting release signal, the ULNs driver 160 to release the transmit waiting state and to transmit, to the application program 110, a response corresponding to an event completion notification for transmission.

FIG. 10 is a block diagram illustrating an example electronic device in a network environment, according to various example embodiments.

Referring to FIG. 10, an electronic device 1001 in a network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In various embodiments, at least one of the components (e.g., the connecting terminal 1078) may be omitted from the electronic device 1001, or one or more other components may be added to the electronic device 1001. In various embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034.

Furthermore, the processor 1020 may operate the system 100 of FIG. 1. That is, the processor 1020 may include the configuration of the system 100 of FIG. 1. The processor 1020 may perform the operation of the processor 910 of FIG. 9.

According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021 or to be dedicated for a designated function. The auxiliary processor 1023 may be implemented separately from the main processor 1021 or as a part of the main processor 1021. Thus, the processor 1020 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an ISP or a CP) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The memory 1030 may perform the role of the memory 920 of FIG. 9.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050 or output the sound via the sound output module 1055 or an external electronic device (e.g., the electronic device 1002) (e.g., a speaker or headphone) directly or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

The connecting terminal 1078 may include a connector via which the electronic device 1001 may be physically connected with the external electronic device (e.g., the electronic device 1002). According to an embodiment, the connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, ISPs, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more CPs that are operable independently from the processor 1020 (e.g., the AP) and support a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device 1004 via the first network 1098 (e.g., a short-range communication network, such as Bluetooth^{TM}, wireless-fidelity (Wi-Fi) direct, or infrared data association (IrDA)) or the second network 1099 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the SIM 1096.

The wireless communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element including a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, cloud computing, distributed computing, mobile edge computing (MEC), or client-server computing technology may be used, for example. The electronic device 1001 may provide ultra low-latency services using, e.g., distributed computing or mobile edge computing. In an embodiment, the external electronic device 1004 may include an Internet-of-Things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), the element may be coupled with the other element directly (e.g., wiredly), wirelessly, or via a third element.

As used in connection with various embodiments of the disclosure, the term "module" may include a unit implemented in hardware, software, or firmware, or any combination thereof, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the "non-transitory" storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an example embodiment, a method of using a ULNs may include determining, when the ULNs loader 120 detects an execution of the application program 110, whether the ULNs manager 140 corresponding to the application program 110 exists, loading, by the ULNs loader 120, the ULNs manager 140 corresponding to the application program 110 when, as a result of the determination, the ULNs manager 140 corresponding to the application program 110 exists, transmitting, by the system call hooker 130, when the application program 110 calls a function related to a network, the called function to the ULNs manager 140 when the ULNs manager 140 corresponding to the application program 110 exists, and calling, when the ULNs manager 140 receives the called function, the called function by changing a parameter of the called function to match the form of a corresponding function of the ULNs 142 and transmitting, when receiving a response corresponding to the called function, the response to the application program 110 by changing the response to match the form of the library 150.

According to an example embodiment, the method of using the ULNs may further include transmitting, by the system call hooker 130, the called function to the library 150 when the ULNs manager 140 corresponding to the application program 110 does not exist.

According to an example embodiment, the method of using the ULNs may further include determining whether the ULNs manager 140 corresponding to the application program 110 is loaded, when the system call hooker 130 detects a socket function call of the application program 110, transmitting, by the system call hooker 130, the socket function call to the ULNs manager 140 when the ULNs manager 140 corresponding to the application program 110 is loaded, when the ULNs manager 140 receives the socket function call, generating a first socket through a socket function of the ULNs 142 corresponding to the socket function call, obtaining a file identifier of the first socket, generating a second socket through a socket function of the library 150, and obtaining a file identifier of the second socket, mapping, by the ULNs manager 140, the file identifier of the first socket to the file identifier of the second socket and storing the mapped file identifier of the first socket and the mapped file identifier of the second socket in a mapping table, and returning, by the ULNs manager 140, the file identifier of the second socket to the application program 110.

According to an example embodiment, the method of using the ULNs may further include transmitting, by the system call hooker 130, the socket function call to the library 150 when the ULNs manager 140 corresponding to the application program 110 is not loaded.

According to an example embodiment, the method of using the ULNs may further include determining whether the ULNs manager 140 corresponding to the application program 110 is loaded, when the system call hooker 130 detects a connect function call of the application program 110, transmitting, by the system call hooker 130, the connect function call to the ULNs manager 140 when the ULNs manager 140 corresponding to the application program 110 is loaded, determining, when the ULNs manager 140 receives the connect function call, by determining a file identifier of a socket included in the connect function call through the mapping table, whether a file identifier of the first socket corresponding to the file identifier of the socket exists, transmitting, by the ULNs manager 140, to a ULNs driver 160, information indicating that a socket exists to attempt a connection when, as a result of the determination, the file identifier of the first socket corresponding to the file identifier of the socket included in the connect function call exists, assigning, by the ULNs driver 160, a port number to the second socket and transmitting the assigned port number to the ULNs manager 140, assigning, by the ULNs manager 140, the assigned port number to the first socket, and calling, by the ULNs manager 140, a connect function of the ULNs 142, and when receiving a response of the connect function of the ULNs 142, transmitting, to the application program 110, the response of the connect function of the ULNs 142 by changing the response to match the form of the library 150.

According to an example embodiment, the method of using the ULNs may further include transmitting, by the system call hooker 130, the connect function call to the library 150 when the ULNs manager 140 corresponding to the application program 110 is not loaded.

According to an example embodiment, the method of using the ULNs may further include transmitting the connect function call to the library 150 when, as a result of the determination, the file identifier of the first socket corresponding to the file identifier of the socket included in the connect function call does not exist.

According to an example embodiment, the method of using the ULNs may further include determining whether the ULNs manager 140 corresponding to the application program 110 is loaded, when the system call hooker 130 detects a send function call of the application program 110, transmitting, by the system call hooker 130, the send function call to the ULNs manager 140 when the ULNs manager 140 corresponding to the application program 110 is loaded, determining, when the ULNs manager 140 receives the send function call, by determining a file identifier of a socket included in the send function call through the mapping table, whether a file identifier of the first socket corresponding to the file identifier of the socket exists, and calling, by the ULNs manager 140, a send function of the ULNs 142 when, as a result of the determination, the file identifier of the first socket corresponding to the file identifier of the socket included in the send function call exists and transmitting, by the ULNs manager 140, to the application program 110, when receiving a response of the send function of the ULNs 142, the response of the send function of the ULNs 142 by changing the response to match the form of the library 150.

According to an example embodiment, the method of using the ULNs may further include determining whether the ULNs manager 140 corresponding to the application program 110 is loaded, when the system call hooker 130 detects a receive function call of the application program 110, transmitting, by the system call hooker 130, the receive function call to the ULNs manager 140 when the ULNs manager 140 corresponding to the application program 110 is loaded, determining, when the ULNs manager 140 receives the receive function call, by determining a file identifier of a socket included in the receive function call through the mapping table, whether a file identifier of the first socket corresponding to the file identifier of the socket exists, and calling, by the ULNs manager 140, a receive function of the ULNs 142, when, as a result of the determination, the file identifier of the first socket corresponding to the file identifier of the socket included in the receive call exists and transmitting, by the ULNs manager 140, to the application program 110, when receiving a response of the receive function of the ULNs 142, the response of the receive function of the ULNs 142 by changing the response to match the form of the library 150.

According to an example embodiment, the method of using the ULNs may further include generating, by the application program 110, a receive thread for receiving and switching the receive thread to a receive waiting state, when the ULNs 142 receives a packet through a network, processing the packet and transmitting a completion of processing the packet to the ULNs manager 140, transmitting, by the ULNs manager 140, the completion of processing the packet to the ULNs driver 160, transmitting a receive waiting release signal to the receive thread in the receive waiting state when the ULNs driver 160 receives the completion of processing the packet, and when the receive thread receives the receive waiting release signal, releasing, by determining a socket state of the ULNs 142, the receive waiting state when the received packet exists and transmitting, to the application program 110, a response corresponding to an event completion notification for reception.

According to an example embodiment, the method of using the ULNs may further include, when the application program 110 receives the response of the send function, generating a transmit thread for transmitting and switching the transmit thread to a transmit waiting state, transmitting, to the ULNs driver 160, a transmission completion indicating that transmission is completed, when the ULNs manager 140 detects a completion of transmission processing of the ULNs 142, transmitting a transmit waiting release signal to the transmit thread in the transmit waiting state when the ULNs driver 160 receives the transmission completion, and when the transmit thread receives the transmit waiting release signal, releasing the transmit waiting state and transmitting, to the application program 110, a response corresponding to an event completion notification for transmission.

According to an example embodiment, the ULNs loader, the ULNs manager, and the system call hooker may be programs that operate at a user layer.

According to an example embodiment, a system for using a ULNs may include memory and at least one processor, comprising processing circuitry, wherein at least one processor, individually or in any combination, may be configured to cause the system to: determine, when the ULNs loader 120 detects an execution of the application program 110, whether the ULNs manager 140 corresponding to the application program 110 exists, load, by the ULNs loader 120, the ULNs manager 140 corresponding to the application program 110 when, as a result of the determination, the ULNs manager 140 corresponding to the application program 110 exists, transmit, by the system call hooker 130, when the application program 110 calls a function related to a network, the called function to the ULNs manager 140 when the ULNs manager 140 corresponding to the application program 110 exists, call, when the ULNs manager 140 receives the called function, the called function by changing a parameter of the called function to match the form of a corresponding function of the ULNs 142 and transmit, when receiving a response corresponding to the called function, the response to the application program 110 by changing the response to match the form of the library 150.

According to an example embodiment, at least one processor, individually or in any combination, may be configured to cause the system to transmit, through the system call hooker 130, the called function to the library 150 when the ULNs manager 140 corresponding to the application program 110 does not exist.

According to an example embodiment, at least one processor, individually or in any combination, may be configured to cause the system to determine whether the ULNs manager 140 corresponding to the application program 110 is loaded, when the system call hooker 130 detects a socket function call of the application program 110, transmit, through the system call hooker 130, the socket function call to the ULNs manager 140 when the ULNs manager 140 corresponding to the application program 110 is loaded, when the ULNs manager 140 receives the socket function call, generate a first socket through a socket function of the ULNs 142 corresponding to the socket function call, obtain a file identifier of the first socket, generate a second socket through a socket function of the library 150, and obtain a file identifier of the second socket, map, through the ULNs manager 140, the file identifier of the first socket to the file identifier of the second socket and store the mapped file identifier of the first socket and the mapped file identifier of the second socket in a mapping table, and return, through the ULNs manager 140, the file identifier of the second socket to the application program 110.

According to an example embodiment, at least one processor, individually or in any combination, may be configured to cause the system to determine whether the ULNs manager 140 corresponding to the application program 110 is loaded, when the system call hooker 130 detects a connect function call of the application program 110, transmit, through the system call hooker 130, the connect function call to the ULNs manager 140 when the ULNs manager 140 corresponding to the application program 110 is loaded, determine, when the ULNs manager 140 receives the connect function call, by determining a file identifier of a socket included in the connect function call through the mapping table, whether a file identifier of the first socket corresponding to the file identifier of the socket exists, transmit, through the ULNs manager 140, to the ULNs driver 160, information indicating that a socket exists to attempt a connection when, as a result of the determination, the file identifier of the first socket corresponding to the file identifier of the socket included in the connect function call exists, assign, through the ULNs driver 160, a port number to the second socket and transmit the assigned port number to the ULNs manager 140, assign, through the ULNs manager 140, the assigned port number to the first socket, and call, through the ULNs manager 140, a connect function of the ULNs 142, and when receiving a response of the connect function of the ULNs 142, transmit, to the application program 110, the response of the connect function of the ULNs 142 by changing the response to match the form of the library 150.

According to an example embodiment, at least one processor, individually or in any combination, may be configured to cause the system to determine whether the ULNs manager 140 corresponding to the application program 110 is loaded, when the system call hooker 130 detects a send function call of the application program 110, transmit, through the system call hooker 130, the send function call to the ULNs manager 140 when the ULNs manager 140 corresponding to the application program 110 is loaded, determine, when the ULNs manager 140 receives the send function call, by determining a file identifier of a socket included in the send function call through the mapping table, whether a file identifier of the first socket corresponding to the file identifier of the socket exists, and call, through the ULNs manager 140, a send function of the ULNs 142 when, as a result of the determination, the file identifier of the first socket corresponding to the file identifier of the socket included in the send function call exists and transmit, through the ULNs manager 140, to the application program 110, when receiving a response of the send function of the ULNs 142, the response of the send function of the ULNs 142 by changing the response to match the form of the library 150.

According to an example embodiment, at least one processor, individually or in any combination, may be configured to determine whether the ULNs manager 140 corresponding to the application program 110 is loaded, when the system call hooker 130 detects a receive function call of the application program 110, transmit, through the system call hooker 130, the receive function call to the ULNs manager 140 when the ULNs manager 140 corresponding to the application program 110 is loaded, determine, when the ULNs manager 140 receives the receive function call, by determining a file identifier of a socket included in the receive function call through the mapping table, whether a file identifier of the first socket corresponding to the file identifier of the socket exists, and call, through the ULNs manager 140, a receive function of the ULNs 142, when, as a result of the determination, the file identifier of the first socket corresponding to the file identifier of the socket included in the receive call exists and transmit, through the ULNs manager 140, to the application program 110, when receiving a response of the receive function of the ULNs 142, the response of the receive function of the ULNs 142 by changing the response to match the form of the library 150.

According to an example embodiment, at least one processor, individually or in any combination, may be configured to cause the system to generate, through the application program 110, a receive thread for receiving and switch the receive thread to a receive waiting state, when the ULNs 142 receives a packet through a network, process the packet and transmit a completion of processing the packet to the ULNs manager 140, transmit, through the ULNs manager 140, the completion of processing the packet to the ULNs driver 160, transmit a receive waiting release signal to the receive thread in the receive waiting state when the ULNs driver 160 receives the completion of processing the packet, and when the receive thread receives the receive waiting release signal, release, by determining a socket state of the ULNs 142, the receive waiting state when the received packet exists and transmit, to the application program 110, a response corresponding to an event completion notification for reception.

According to an example embodiment, at least one processor, individually or in any combination, may be configured to cause the system to, when the application program 110 receives the response of the send function, generate a transmit thread for transmitting and switch the transmit thread to a transmit waiting state, transmit, to the ULNs driver 160, a transmission completion indicating that transmission is completed, when the ULNs manager 140 detects a completion of transmission processing of the ULNs 142, transmit a transmit waiting release signal to the transmit thread in the transmit waiting state when the ULNs driver 160 receives the transmission completion, and when the transmit thread receives the transmit waiting release signal, release the transmit waiting state and transmit, to the application program 110, a response corresponding to an event completion notification for transmission.

The method according to various example embodiments described above may be recorded in non-transitory computer-readable storage media including program instructions to implement various operations of the various example embodiments described above. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable storage media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random-access memory (RAM), flash memory, and the like. Examples of program instructions include both machine code, such as code produced by a compiler, and files including higher level code that may be executed by the computer using an interpreter. The hardware devices described above may be configured to act as one or more software modules in order to perform the operations of the various embodiments, or vice versa.

Software may include a computer program, a piece of code, an instruction, or one or more combinations thereof, to independently or collectively instruct or configure a processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While various example embodiments are described with reference to the drawings, it will be apparent to one of ordinary skill in the art that various alterations and modifications in form and details may be made in these embodiments without departing from the spirit and scope of the disclosure, including claims and their equivalents. For example, suitable results may be achieved if the described techniques are performed in a different order, and/or if components in a described system, architecture, device, or circuit are combined in a different manner, or replaced or supplemented by other components or their equivalents. It will also be understood that any of the embodiment(s) described herein may be used in conjunction with any other embodiment(s) described herein.

Therefore, other implementations, other embodiments, and equivalents to the claims are also within the scope of the disclosure, including the following claims.

What is claimed is:

1. A method of using a user-layer network solution (ULNs), the method comprising:
determining, based on a ULNs loader detecting an execution of an application program, whether a ULNs manager corresponding to the application program exists;
loading, by the ULNs loader, the ULNs manager corresponding to the application program based on, as a result of the determination, the ULNs manager corresponding to the application program existing;
transmitting, by a system call hooker, based on the application program calling a function related to a network, the called function to the ULNs manager based on the ULNs manager corresponding to the application program existing; and
calling, based on the ULNs manager receiving the called function, the called function by changing a parameter of the called function to match a form of a corresponding function of a ULNs and transmitting, based on receiving a response corresponding to the called function, the response to the application program by changing the response to match a form of a library.

2. The method of claim 1, further comprising:
transmitting, by the system call hooker, the called function to the library based on the ULNs manager corresponding to the application program not existing.

3. The method of claim 1, further comprising:
determining whether the ULNs manager corresponding to the application program is loaded, based on the system call hooker detecting a socket function call of the application program;
transmitting, by the system call hooker, the socket function call to the ULNs manager based on the ULNs manager corresponding to the application program being loaded;
based on the ULNs manager receiving the socket function call, generating a first socket through a socket function of a ULN corresponding to the socket function call, obtaining a file identifier of the first socket, generating a second socket through a socket function of a library, and obtaining a file identifier of the second socket;
mapping, by the ULNs manager, the file identifier of the first socket to the file identifier of the second socket and storing the mapped file identifier of the first socket and the mapped file identifier of the second socket in a mapping table; and
returning, by the ULNs manager, the file identifier of the second socket to the application program.

4. The method of claim 3, further comprising:
transmitting, by the system call hooker, the socket function call to a library based on the ULNs manager corresponding to the application program not being loaded.

5. The method of claim 3, further comprising:
determining whether the ULNs manager corresponding to the application program is loaded, based on the system call hooker detecting a connect function call of the application program;
transmitting, by the system call hooker, the connect function call to the ULNs manager based on the ULNs manager corresponding to the application program being loaded;
determining, based on the ULNs manager receiving the connect function call, by determining a file identifier of a socket comprised in the connect function call through the mapping table, whether a file identifier of the first socket corresponding to the file identifier of the socket exists;
transmitting, by the ULNs manager, to a ULNs driver, information indicating that a socket exists to attempt a connection when, as a result of the determination, the file identifier of the first socket corresponding to the file identifier of the socket comprised in the connect function call exists;
assigning, by the ULNs driver, a port number to the second socket and transmitting the assigned port number to the ULNs manager;
assigning, by the ULNs manager, the assigned port number to the first socket; and
calling, by the ULNs manager, a connect function of the ULNs, and based on receiving a response of the connect function of the ULNs, transmitting, to the application program, the response of the connect function of the ULNs by changing the response to match a form of a library.

6. The method of claim 5, further comprising:
transmitting, by the system call hooker, the connect function call to the library based on the ULNs manager corresponding to the application program not being loaded.

7. The method of claim 5, further comprising:
transmitting the connect function call to the library based on, as a result of the determination, the file identifier of the first socket corresponding to the file identifier of the socket comprised in the connect function call not existing.

8. The method of claim 3, further comprising:
determining whether the ULNs manager corresponding to the application program is loaded, based on the system call hooker detecting a send function call of the application program;
transmitting, by the system call hooker, the send function call to the ULNs manager based on the ULNs manager corresponding to the application program being loaded;
determining, based on the ULNs manager receiving the send function call, by determining a file identifier of a socket comprised in the send function call through the mapping table, whether a file identifier of the first socket corresponding to the file identifier of the socket exists; and
calling, by the ULNs manager, a send function of the ULNs based on, as a result of the determination, the file identifier of the first socket corresponding to the file identifier of the socket comprised in the send function call existing and transmitting, by the ULNs manager, to the application program, based on receiving a response of the send function of the ULNs, the response of the send function of the ULNs by changing the response to match a form of a library.

9. The method of claim 3, further comprising:
determining whether the ULNs manager corresponding to the application program is loaded, based on the system call hooker detecting a receive function call of the application program;
transmitting, by the system call hooker, the receive function call to the ULNs manager based on the ULNs manager corresponding to the application program being loaded;
determining, based on the ULNs manager receiving the receive function call, by determining a file identifier of a socket comprised in the receive function call through the mapping table, whether a file identifier of the first socket corresponding to the file identifier of the socket exists; and
calling, by the ULNs manager, a receive function of the ULNs, based on, as a result of the determination, the file identifier of the first socket corresponding to the file identifier of the socket comprised in the receive call existing and transmitting, by the ULNs manager, to the application program, based on receiving a response of the receive function of the ULNs, the response of the receive function of the ULNs by changing the response to match a form of a library.

10. The method of claim 1, further comprising:
generating, by the application program, a receive thread for receiving and switching the receive thread to a receive waiting state;
based on the ULN receiving a packet through a network, processing the packet and transmitting a completion of processing the packet to the ULNs manager;transmitting, by the ULNs manager, the completion of processing the packet to the ULNs driver;
transmitting a receive waiting release signal to the receive thread in the receive waiting state based on the ULNs driver receiving the completion of processing the packet; and
based on the receive thread receiving the receive waiting release signal, releasing, by determining a socket state of the ULNs, the receive waiting state when the received packet exists and transmitting, to the application program, a response corresponding to an event completion notification for reception.

11. The method of claim 8, further comprising:
based on the application program receiving the response of the send function, generating a transmit thread for transmitting and switching the transmit thread to a transmit waiting state;
transmitting, to the ULNs driver, a transmission completion indicating that transmission is completed, based on the ULNs manager detecting a completion of transmission processing of the ULNs;
transmitting a transmit waiting release signal to the transmit thread in the transmit waiting state based on the ULNs driver receiving the transmission completion; and
based on the transmit thread receiving the transmit waiting release signal, releasing the transmit waiting state and transmitting, to the application program, a response corresponding to an event completion notification for transmission.

12. A non-transitory computer-readable storage medium storing instructions,
wherein, the instructions, when executed by at least one processor, comprising processing circuitry, individually or in any combination, cause a system to perform operations comprising:
determining, based on a user-layer network solution (ULNs) loader detecting an execution of an application program, whether a ULNs manager corresponding to the application program exists;
loading, through the ULNs loader, the ULNs manager corresponding to the application program based on, as a result of the determination, the ULNs manager corresponding to the application program existing;
transmitting, through a system call hooker, based on the application program calling a function related to a network, the called function to the ULNs manager based on the ULNs manager corresponding to the application program existing; and
calling, based on the ULNs manager receiving the called function, the called function by changing a parameter of the called function to match a form of a corresponding function of a ULNs and transmitting, based on receiving a response corresponding to the called function, the response to the application program by changing the response to match a form of a library.

13. A system for using a user-layer network solution (ULNs), the system comprising:
memory; and
at least one processor, comprising processing circuitry;
wherein at least one processor, individually or in any combination, is configured to cause the system to:
determine, based on a ULNs loader detecting an execution of an application program, whether a ULNs manager corresponding to the application program exists;
load, through the ULNs loader, the ULNs manager corresponding to the application program based on, as a result of the determination, the ULNs manager corresponding to the application program existing;
transmit, through a system call hooker, based on the application program calling a function related to a network, the called function to the ULNs manager based on the ULNs manager corresponding to the application program existing;
call, based on the ULNs manager receiving the called function, the called function by changing a parameter of the called function to match a form of a corresponding function of a ULNs and transmit, based on receiving a response corresponding to the called function, the response to the application program by changing the response to match a form of a library.

14. The system of claim 13, wherein at least one processor, individually or in any combination, is configured to cause the system to:
determine whether the ULNs manager corresponding to the application program is loaded, based on the system call hooker detecting a socket function call of the application program;
transmit, through the system call hooker, the socket function call to the ULNs manager based on the ULNs manager corresponding to the application program being loaded;
based on the ULNs manager receiving the socket function call, generate a first socket through a socket function of a ULNs corresponding to the socket function call, obtain a file identifier of the first socket, generate a second socket through a socket function of a library, and obtain a file identifier of the second socket;
map, through the ULNs manager, the file identifier of the first socket to the file identifier of the second socket and store the mapped file identifier of the first socket and the mapped file identifier of the second socket in a mapping table; and
return, through the ULNs manager, the file identifier of the second socket to the application program.

15. The system of claim 13, wherein at least one processor, individually or in any combination, is configured to cause the system to:
generate, through the application program, a receive thread for receiving and switch the receive thread to a receive waiting state;
based on the ULN receiving a packet through a network, process the packet and transmit a completion of processing the packet to the ULNs manager;
transmit, through the ULNs manager, the completion of processing the packet to the ULNs driver;
transmit a receive waiting release signal to the receive thread in the receive waiting state based on the ULNs driver receiving the completion of processing the packet; and
based on the receive thread receiving the receive waiting release signal, release, by determining a socket state of the ULNs, the receive waiting state based on the received packet existing and transmit, to the application program, a response corresponding to an event completion notification for reception.
